(19) United States
(12) Patent Application Publication
(10) Pub. No.: US 2004/0193639 A1
(43) Pub. Date: Sep. 30, 2004

(54) Method and system for projectwise management of computer data objects

(75) Inventors: Ofer Bergman, Tel Aviv (IL); Rafi Nachmias, Rosh Ha'ayin (IL)

Correspondence Address: DR. MARK FRIEDMAN LTD., c/o Bill Polkinghorn, Discovery Dispatch, 9003 Florin Way, Upper Marlboro, MD, 20772, US

(73) Assignee: RAMOT UNIVERSITY AUTHORITY FOR APPLIED RESEARCH AND INDUSTRIAL DEVELOPMENT LTD.

(21) Appl. No.: 10/400,409

(22) Filed: Mar. 28, 2003

(51) Int. Cl. G06F 17/00

(52) U.S. Cl. 707/103 R

(57) ABSTRACT

A method and system for managing data objects that are organized hierarchically according to type. The data objects are assigned to projects and subprojects independently of their type. At any one time, only one of the projects is “active”: by default, identifiers of data objects assigned to the active project are displayed for user access and newly created data objects are assigned to the active project. One embodiment of the invention uses a database to mirror the existing hierarchy. Another embodiment keeps all the data objects of each project in a single respective folder. Identifiers of the data objects of the active project are made collectively accessible at a graphical user interface, along with a project history.

### FIELD AND BACKGROUND OF THE INVENTION

The present invention relates to the management of computer data objects and, more particularly, to a method and system for managing computer data objects on a project-wise basis.

Computer users generally deal with data objects of different types, depending on the user applications that create and/or manage the files. For example, the user of a computer whose operating system is Microsoft Windows™ might deal with document files created and/or managed by Microsoft Word™, e-mail messages created and/or managed by Microsoft Outlook™ and bookmarks created and/or managed by Internet Explorer™.

Modern operating systems, such as Microsoft Windows™ and Unix, organize most data objects in a hierarchy of groups of data objects. These groups are generally referred to as “folders” (in Microsoft Word™, for example) or as “directories” (in Unix, for example). In what follows, Microsoft Word™ terminology generally will be used. The hierarchy has a tree-like structure, starting from a “root folder”. The other folders are the branch points of the tree. The leaves of the tree are the data objects that are either empty folders or data objects other than folders. A member of the hierarchy is identified by its path, i.e., a list of the folders to which it belongs, all the way back to the root folder. Some types of data objects, for example Microsoft Word™ documents, are files that are stored by users in arbitrarily selected folders. Other types of data objects are kept in folders that are associated with the applications that manage them. For example, in many implementations of Microsoft Windows™, Internet Explorer™ keeps bookmarks in a subfolder of the “Documents and Settings” folder called “Favorites” and in subfolders of the “Favorites” folder. Still other types of data objects are presented to the user by the associated applications as though they were associated with respective folders, even though these data objects actually are managed by their applications independently of the hierarchy. For example, the e-mail messages of Microsoft Outlook™, which are presented to the user as though they were files in folders such as the “inbox” folder and the “sent messages” folder, actually are records in a database. Typically, data objects that are files have file extensions that indicate the associated user application. For example, Microsoft Word™ documents have the file extension “.doc”.

Modern operating systems such as Microsoft Windows™ include graphical user interfaces that allow users to interact with the data objects via visual identifiers of the data objects. In Microsoft Windows™, for example, the identifiers generally are icons and/or text such as file names. Typically, a user accesses a data object by designating the associated identifier using an appropriate input device, for example by using a mouse to move a cursor to the identifier and then left-clicking the mouse.

Most computer users work on several projects related to their work, studies or personal usage. Because of the close association of user applications, such as Microsoft Outlook™ and Internet Explorer™, with particular folders, the data objects associated with a particular project generally are spread over several folders. For example, a chemistry student using a computer whose operating system is Microsoft Windows™ might store chemistry-related Microsoft Windows™ files in a “chemistry” subfolder of the “My Documents” folder, chemistry-related bookmarks in a “chemistry” folder that is managed by Internet Explorer™ and chemistry-related e-mail messages in one or more “chemistry” folders managed by Microsoft Outlook™. The user must keep track of all the separate folders associated with a given project, which can become confusing if a user has many folders for many projects. Furthermore, a user is not able to see all of a project's data objects together in a unified display in order to get an overview of the project. The present method of project management also is time consuming: when a user is working on a data object of a project and wants to open another project data object in a different folder, he or she usually needs to navigate to the folder of the desired data object.

There is thus a widely recognized need for, and it would be highly advantageous to have, a project-wise method of managing computer data objects that are otherwise organized according to a hierarchy that is not related to the projects.

### SUMMARY OF THE INVENTION

According to the present invention there is provided a method of managing a plurality of data objects organized according to a hierarchy, each data object having a respective type, including the steps of: (a) assigning each of a plurality of sets of the data objects to a respective project in a manner independent of the respective types of the data objects; and (b) designating a single one of the projects as an active project.

According to the present invention there is provided a method of managing a plurality of data objects, each data object having a respective type, including the steps of: (a) assigning each of a plurality of sets of the data objects to a respective project in a manner independent of the respective types of the data objects; and (b) for one of the projects, displaying a history of the project at a graphical user interface.

According to the present invention there is provided a method of managing a plurality of data objects, each data object having a respective type, including the steps of: (a) assigning each of a plurality of sets of the data objects to a respective project in a manner independent of the respective types of the data objects; and (b) providing at least one the project with at least one respective project attribute.

According to the present invention there is provided a method of managing a plurality of data objects, each data object having a respective type, including the steps of: (a) assigning each of a plurality of sets of the data objects to a respective project in a manner independent of the respective types of the data objects; and (b) for one of the projects, archiving at least one of the data objects assigned to the one project.

According to the present invention there is provided a method of managing a plurality of data objects, each data object having a respective data type, including the steps of: (a) assigning each of a plurality of sets of the data objects to a respective project in a manner independent of the respective types of the data objects; (b) accessing a document that includes at least one hyperlink; and (c) creating a pre-accessed bookmark that corresponds to one of the at least one hyperlink and that is assigned to one of the projects.

According to the present invention there is provided a system for managing a plurality of data objects, each data object having a respective type, the system including: (a) a memory for storing the data objects; and (b) a processor for: (i) assigning each of a plurality of sets of the data objects to a respective project in a manner independent of the respective types of the data objects; and (ii) designating a single one of the projects as an active project.

According to the present invention there is provided a system for managing a plurality of data objects, each data object having a respective type, the system including: (a) a memory for storing the data objects; and (b) a processor for: (i) assigning each of a plurality of sets of the data objects to a respective project in a manner independent of the respective types of the data objects, and (ii) displaying respective histories of the projects at a graphical user interface; and (c) a mechanism for implementing the graphical user interface.

According to the present invention there is provided a system for managing a plurality of data objects, each data object having a respective type, the system including: (a) a memory for storing the data objects; and (b) a processor for: (i) assigning each of a plurality of sets of the data objects to a respective project in a manner independent of the respective types of the data objects, and (ii) providing at least one the project with at least one respective project attribute.

According to the present invention there is provided a system for managing a plurality of data objects, each data object having a respective type, the system including: (a) a memory for storing the data objects; and (b) a processor for: (i) assigning each of a plurality of sets of the data objects to a respective project in a manner independent of the respective types of the data objects, and (ii) for one of the projects, archiving at least one of the data objects assigned to the one project.

According to the present invention there is provided a system for managing a plurality of data objects, each data object having a respective type, the system including: (a) a memory for storing the data objects; and (b) a processor for: (i) assigning each of a plurality of sets of the data objects to a respective project in a manner independent of the respective types of the data objects, (ii) accessing a document that includes at least one hyperlink, and (iii) creating a pre-accessed bookmark that corresponds to one of the at least one hyperlink and that is assigned to one of the projects.

According to the present invention there is provided a computer readable storage medium having computer readable code embodied on the computer readable storage medium, the computer readable code for managing a plurality of data objects, each data object having a respective type, the computer readable code including: (a) program code for assigning each of a plurality of sets of the data objects to a respective project in a manner independent of the respective types of the data objects; and (b) program code for designating a single one of the projects as an active project.

According to the present invention there is provided a computer readable storage medium having computer readable code embodied on the computer readable storage medium, the computer readable code for managing a plurality of data objects, each data object having a respective type, the computer readable code including: (a) program code for assigning each of a plurality of sets of the data objects to a respective project in a manner independent of the respective types of the data objects; and (b) program code for displaying respective histories of the projects at a graphical user interface.

According to the present invention there is provided a computer readable storage medium having computer readable code embodied on the computer readable storage medium, the computer readable code for managing a plurality of data objects, each data object having a respective type, the computer readable code including: (a) program code for assigning each of a plurality of sets of the data objects to a respective project in a manner independent of the respective types of the data objects; and (b) program code for providing at least one the project with at least one respective project attribute.

According to the present invention there is provided a computer readable storage medium having computer readable code embodied on the computer readable storage medium, the computer readable code for managing a plurality of data objects, each data object having a respective type, the computer readable code including: (a) program code for assigning each of a plurality of sets of the data objects to a respective project in a manner independent of the respective types of the data objects; and (b) program code for, for one of the projects, archiving at least one of the data objects assigned to the one project.

According to the present invention there is provided a computer readable storage medium having computer readable code embodied on the computer readable storage medium, the computer readable code for managing a plurality of data objects, each data object having a respective type, the computer readable code including: (a) program code for assigning each of a plurality of sets of the data objects to a respective project in a manner independent of the respective types of the data objects; (b) program code for accessing a document that includes at least one hyperlink; and (c) program code for creating a pre-accessed bookmark that corresponds to one of the at least one hyperlink and that is assigned to one of the projects.

According to the present invention there is provided a method of extracting information from a document that includes at least one hyperlink, including the steps of: (a) accessing the document; and (b) creating a pre-accessed bookmark that corresponds to one of the at least one hyperlink.

According to the present invention there is provided a system for extracting information from a document that includes at least one hyperlink, including: (a) a memory for storing the document; and (b) a processor for: (i) accessing the document, and (ii)creating a pre-accessed bookmark that corresponds to one of the at least one hyperlink.

According to the present invention there is provided a computer readable storage medium having computer readable code embodied on the computer readable storage medium, the computer readable code for extracting information from a document that includes at least one hyperlink, the computer readable code including: (a) program code for accessing the document; and (b) program code for creating a pre-accessed bookmark that corresponds to one of the at least one hyperlink.

According to the present invention, for each project to be managed, the relevant set of data objects is assigned to that project, no matter what the types of the data objects are. For example, the data objects assigned to a project may be files, e-mail messages, and/or browser bookmarks. At any given time, one of the projects may be designated as the “active” project. While a project is “active”, the default folder for saving new data objects and for opening stored data objects is a folder associated with the project.

Preferably, data objects are assigned to a project by steps including associating each project with at least one folder of the hierarchy. As understood herein a “folder” is either an actual folder of the operating system or an entity of a user application that appears to a user as a folder of the operating system. For example, the entities used by Microsoft Outlook™ to classify e-mail messages are considered herein to be “folders” even though Microsoft Outlook™ actually stores all of its e-mail messages in a common database. In a first preferred embodiment of the present invention, a new project is created by creating the corresponding folders in respective project root zones, which preferably are themselves folders of the hierarchy. In this preferred embodiment, project data objects are managed via a database, for example a tabular database, that includes paths to the data objects of the various projects. In a second preferred embodiment of the present invention, each project is associated with a single respective folder of the hierarchy. This second embodiment allows a user to store a diverse assortment of data objects, including documents, bookmarks and pointers to e-mail messages, in the single folder.

One way of designating the active project is by accessing a data object that has been assigned to the project, for example by opening a Microsoft Word™ document that has been assigned to the project. Another way of designating the active project is by associating the project with a folder of the hierarchy (in the two preferred embodiments of the present invention, this is done when the project is created) and then accessing that folder.

At any time, the user can inactivate the active project and designate a different project as “active”. For example, overriding the default folder for opening an existing data object changes the “active” folder to the project associated with the new folder if such a project exists.

Preferably, the projects are provided with respective project-wide attributes. Examples of the attributes that a project can have include a home page, a special graphical design, a set of one or more management tools, a set of one or more notes, a set of one or more correspondents, and a password. Preferred management tools include a calendar and a Gantt chart.

Preferably, selected data objects of the projects are provided with respective attributes. For example, one of the data objects assigned to the active project may be interactively marked as a task.

Preferably, when a document that includes hyperlinks is accessed, the present invention includes the step of creating a new data object that corresponds to one of the hyperlinks and that is assigned to one of the projects. Most preferably, the new data object is a pre-accessed bookmark. A “pre-accessed” bookmark is a bookmark that points to a document that actually has yet to be accessed.

Preferably, the present invention includes the step of making respective identifiers of some or all of the data objects, that have been assigned to the active project, collectively accessible to the user at a graphical user interface. One way of doing this is to display identifiers of data objects of different types separately at the graphical user interface. Another way of doing this is to display the data objects together in a window of the graphical user interface, regardless of type. Most preferably, a history of the active project also is displayed at the graphical user interface.

Optionally, a new project is created as a subproject of an existing project. In the first preferred embodiment of the present invention, a subproject is created by creating a corresponding new subfolder of one of the folders of the parent project. In the second preferred embodiment of the present invention, a subproject is created by creating a corresponding new subfolder of the single folder of the parent project. Optionally, when a subproject is created, one or more of the attributes of the parent project are bequeathed to the subproject. Optionally, when a subproject is created, one or more of the data objects assigned to the parent project are reassigned to the subproject.

Preferably, the present invention includes the step of archiving at least one of the data objects assigned to the active project. Optionally, only data objects that are not archived are made collectively accessible to the user at the graphical user interface.

The scope of the present invention also includes methods of managing pluralities of data objects of various respective types by assigning sets of data objects to respective projects regardless of type and then treating the projects as described above, irrespective of whether one of the projects is made “active” in the sense defined above. Examples of how the projects are treated include displaying project histories, providing projects with respective attributes, archiving data objects assigned to projects, and creating pre-accessed bookmarks corresponding to hyperlinks of accessed documents. In fact, the creation of a pre-accessed bookmark corresponding to a hyperlink of an accessed document is an aspect of the present invention that is independent of whether the pre-accessed bookmark is assigned to a project.

The scope of the present invention also includes respective systems for implementing the methods of the present invention, as well as respective computer readable storage media having computer readable codes embodied therein for implementing the methods of the present invention.

It is known in the prior art to group data objects such as computer files into “groups”. These groups resemble the “projects” of the present invention; but the prior art does not teach the designation of one of the groups as “active”, as in the present invention. It also is known in the prior art to cross-index hierarchical data objects according to common attributes, independently of the hierarchy. See, for example, U.S. Pat. No. 6,055,527 to Badger et al., U.S. Pat. No. 5,812,995 to Sasaki et al., and especially U.S. Pat. No. 5,544,360 to Lewak et al. Lewak et al. teach the construction and of hybrid folders, independent of the hierarchy, that include all files that share a set of common attributes. Identifiers of the files of a hybrid folder can be displayed together at a graphical user interface, just as the data objects of the active project of the present invention are displayed together at a graphical user interface; but none of the hybrid folders can be designated as “active”, as in the present invention.

The prior art methods also force the users to either work with two distinct hierarchical structures (the folder structure and the alternative structure) or to change the way they work by substituting the alternative hierarchy for the original folder hierarchy. The two preferred embodiments of the present invention are based on the existing folder hierarchy and do not require the introduction of any new hierarchies. The user thus has access to the active project's data objects with only minimal changes in his or her routine.

### BRIEF DESCRIPTION OF THE DRAWINGS

The invention is herein described, by way of example only, with reference to the accompanying drawings, wherein:

FIG. 1 is a prior art hierarchy of data objects;

FIG. 2 shows the data objects of FIG. 1 organized according to projects;

FIGS. 3A and 3B are tables used in a first implementation of the present invention to organize the data objects of FIG. 1 according to projects;

FIG. 4 is a hierarchy used in a second implementation of the present invention to organize the data objects of FIG. 1 according to projects;

FIG. 5 shows graphical user interface menus for making identifiers of data objects of an active project collectively accessible;

FIG. 6 shows a graphical user interface window for making identifiers of data objects of an active project collectively accessible under the second implementation of the present invention;

FIG. 7 is a high level block diagram of a system of the present invention.

### DESCRIPTION OF THE PREFERRED EMBODIMENTS

The present invention is of a method of managing computer data objects that belong to different projects. Specifically, the present invention can be used to simplify the management of computer data objects, such as Microsoft Word™ documents, Microsoft Outlook™ e-mail messages and Internet Explorer™ bookmarks, that belong to the same project but are stored in different folders.

The principles and operation of computer data object management according to the present invention may be better understood with reference to the drawings and the accompanying description.

The implementation of the present invention will be transparent to anyone familiar with a modern operating system such as Microsoft Windows™. Therefore, for the most part, implementation details are omitted in the following discussion. In general terms, the implementation of the present invention is done using a continuously running background program (called a “listener” in Microsoft Windows™) that monitors and responds to file management events of the operating system such as creating, renaming and deleting files and folders.

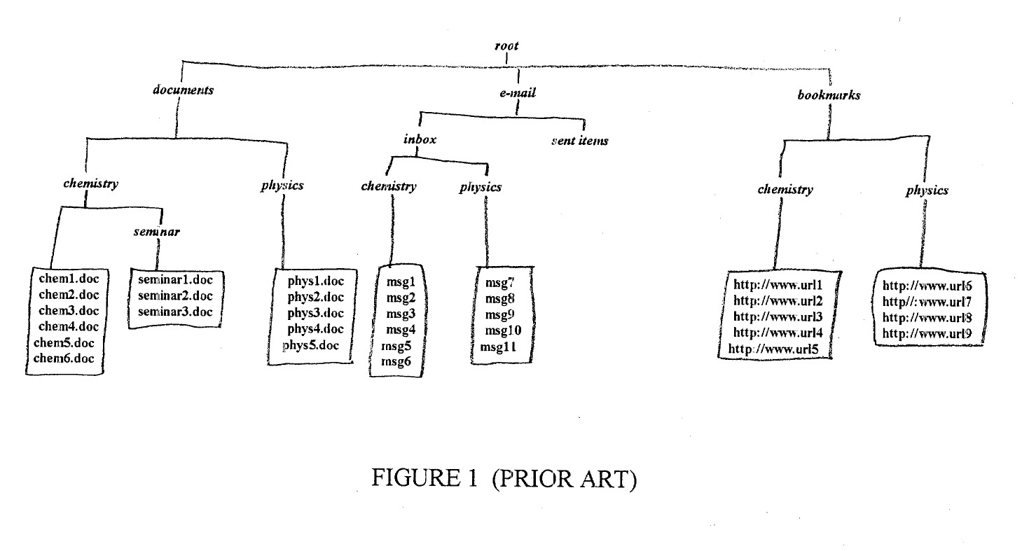

Referring now to the drawings, FIG. 1 shows a simple example of a prior art hierarchy of a set of data objects. The data objects in this case are folders, documents, e-mail messages and bookmarks. Folders are in lower case boldface italics and the other data objects are in lower case boldface. Under a root folder are three highest level subfolders: “documents” for storing the documents, “e-mail” for storing the e-mail messages and “bookmarks” for storing the bookmarks. The “e-mail” folder has two subfolders: “inbox” for incoming e-mail and “sent items” (which is empty in this example) for outgoing mail. The user has defined subfolders of “documents”, “inbox” and “bookmarks” corresponding to two fields in which the user is active: chemistry and physics. The “chemistry” subfolder of “documents” is being used to store six documents related to the field of chemistry. The “chemistry” subfolder of “documents” also has a subfolder of its own, “seminar”, that is being used to store three documents related to seminar work. The “physics” subfolder of “documents” is being used to store five documents related to the field of physics. The “chemistry” subfolder of “inbox” is being used to store six e-mail messages related to the field of chemistry. The “physics” subfolder of “inbox” is being used to store five e-mail messages related to the field of physics. The “chemistry” subfolder of “bookmarks” is being used to store five bookmarks related to the field of chemistry. The “physics” subfolder of “bookmarks” is being used to store four bookmarks related to the field of physics.

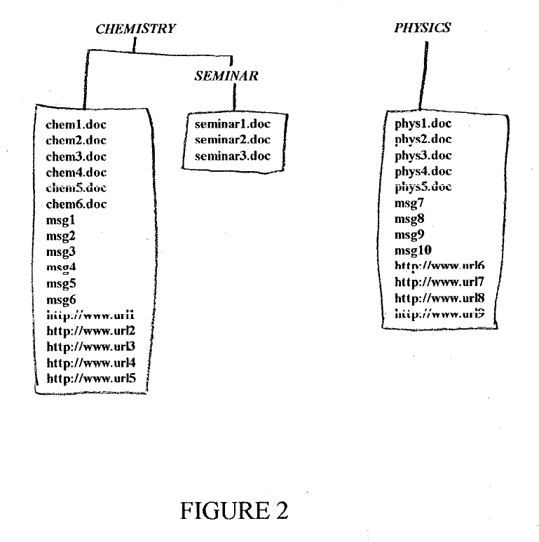

FIG. 2 shows how the present invention organizes the data objects of FIG. 1 into three projects, “PHYSICS”, “CHEMISTRY” and “SEMINAR”, with “SEMINAR” being a subproject of “CHEMISTRY”. In FIG. 2, the projects are in UPPERCASE BOLDFACE ITALICS, and the other data objects are in lower case boldface as in FIG. 1. All the data objects relevant to the field of chemistry, except for the three documents related to laboratory work, are assigned to the project “CHEMISTRY”. Those three documents are assigned to the subproject “SEMINAR”. All the data objects relevant to the field of physics are assigned to the project “PHYSICS”. Formally, the subproject “SEMINAR” is assigned to the project “CHEMISTRY”.

There are two preferred embodiments of the present invention, corresponding to two preferred methods of implementing this organization.

According to the first preferred embodiment, project data objects are organized according to a hierarchy that mirrors the existing hierarchy. Specific data storage locations are designated as “project root zones”. Typically, the project root zones are existing folders of the hierarchy; but entire drives, for example “H:”, also could be designated as project root zones. Folders that are designated as project root zones are called “project root folders” herein. Typically, under Microsoft Windows™, the project root folders include “My Documents” (for Microsoft Windows™ documents), the “Favorites” folder of Internet Explorer™ (for bookmarks) and the “Inbox” and “Sent Items” folders of Microsoft Outlook™ (for e-mail messages). When the user creates a new folder inside a project root folder, then:

(a) if no project yet exists with the name of the new folder, then a new project is created and is given the name of the new folder;

(b) if a project already exists that has the name of the new folder (for example, if a folder of the same name is a subfolder of a different project root folder), then the new folder is assigned to that existing project.

For example, assuming that no subfolder called “chemistry” exists in any of the project root folders, a “chemistry” project is created automatically when a user creates a subfolder of “My Documents” called “chemistry”. All data objects that are subsequently stored in the “chemistry” subfolder of the “My Documents” folder are thereby assigned to the “chemistry” project. In particular, all Microsoft Word™ documents that are subsequently stored in the “chemistry” subfolder of the “My Documents” folder are thereby assigned to the “chemistry” project. Subsequently, when the user creates a subfolder of the “Favorites” folder called “chemistry”, this new subfolder is automatically assigned to the “chemistry” project, and all bookmarks that are subsequently stored in the “chemistry” subfolder of the “Favorites” folder are thereby assigned to the “chemistry” project.

To enable the creation of subprojects, project folders are by default also project root folders. Thus, creating a subfolder called “seminar” in one of the “chemistry” folders creates a “seminar” subproject of the “chemistry” project.

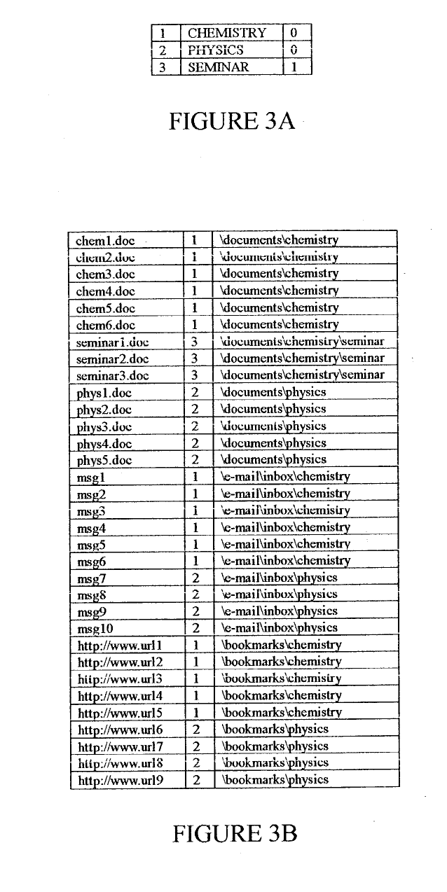

To manage the project hierarchy of the first preferred embodiment, a database is created that relates the data objects, as stored according to the hierarchy of FIG. 1, to their respective projects. This database includes two tables, as illustrated in FIGS. 3A and 3B.

The table of FIG. 3A lists the projects, and has three columns. The first column lists project numbers. The second column lists project names. The third column lists the numbers of parent projects of subprojects. A project that is not a subproject of some other project receives a parent project number of “0”.

The table of FIG. 3B lists the data objects that have been assigned to projects, and also has three columns. The first column lists that data object names. The second column lists the corresponding project numbers. The third column lists the paths, in the hierarchy of FIG. 1, to the data objects.

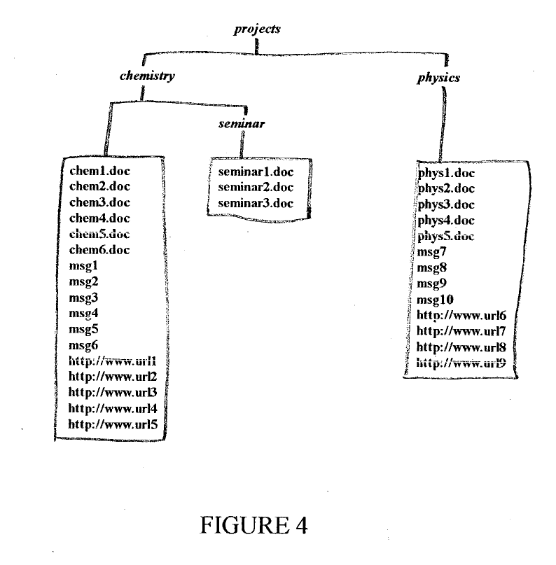

According to a second preferred implementation of the present invention, a folder is created to store all the data objects, or pointers thereof, that are related to a project. FIG. 4 shows the corresponding subhierarchy. Note that FIG. 4 is isomorphic to FIG. 2, except that the projects have become folders, and the highest level projects (chemistry and physics) are subfolders of the folder projects. The documents and the bookmarks are stored as such in their respective project folders, with the bookmarks formerly stored in \bookmarks\chemistry and in \bookmarks\physics being replaced by corresponding pointers. The “e-mail messages” of FIG. 4 actually are pointers to the real e-mail messages, which (for example if the e-mail application is Microsoft Outlook™) still are stored in the e-mail application's database.

Under the second preferred implementation, there is initially only one project root folder (“projects” in the example of FIG. 4). Projects are created by creating subfolders of this folder. As in the case of the first preferred implementation, all project folders also are project root folders, so that creating a subfolder of a project folder creates a subproject of that parent folder's project.

One of the projects is designated by the user as an “active” project. A project is designated as “active” simply by accessing a data object that is assigned to that project, or by explicitly creating a new data object in a folder that is assigned to that project. While a project is active, then, by default, all accesses by user applications to existing data objects are to other data objects of that project, and all newly created data objects are assigned to that project. For example, under the first preferred embodiment of the present invention, opening \documents\chemistry\chem1.doc using Microsoft Word™ makes “chemistry” the active project, as does creating a new file (e.g., “chem7.doc”) in the \documents\chemistry folder. With the “chemistry” project active, selecting the “file/open” menu item of Microsoft Word™ brings up a window in which only the files of the \documents\chemistry folder are displayed; and selecting the “file/save as” menu item of Microsoft Word™ brings up a window for saving the relevant Microsoft Word™ document in the \documents\chemistry folder. These defaults can be overridden by the user in the conventional manner; but overriding these defaults deactivates the active project while possibly activating another project. For example, while the “chemistry” project is active, if a user were to change the target folder of the “file/save as” window from \documents\chemistry (the default) to \documents\physics, then the “chemistry” project would be deactivated, the “physics” project would become the active project, and the document being saved would be saved in the \documents\physics folder. Similarly, if while then “chemistry” project is active, the user were to change the target folder of the “file/save as” window to a folder that is not associated with a project, then the chemistry project would be deactivated and no project would be activated in its stead.

There also is another mechanism for activating and deactivating projects. The present invention is intended to be used via a graphical user interface; and the name of the active project is displayed in a bar at the bottom of the display of the graphical user interface. This bar also allows access (for example via a left mouse click) to a pull-up menu of projects. The entries in this pull-up menu are the names of the projects, and also “NONE” for no active project. Preferably, the names of the most recently accessed currently inactive projects are at the top of the pull-up menu, in inverse chronological order. Selecting the name of a project deactivates the currently active project, if any, and activates the selected project. Selecting “NONE” deactivates the currently active project without activating another project.

Each project has several project-wide attributes, many of which are related to the look and feel of the project as presented at the graphical user interface. One example of a project attribute is a home page that is displayed when a browser is activated while the project is active. Another example of a project attribute is the desktop background that is displayed while the project is active. A third example of a project attribute is the project history, which is a list of recently accessed data objects assigned to the project, in backwards chronological order. In contrast to “save” and “save as” operations, in which the user can override the default to switch to a different project, the maintenance of the history list of a project is automatic and does not allow a switch to a different project. This allows unclassified data objects, such as Web pages, to be added to a project's history list while remaining unclassified. A fourth example of a project attribute is a password that the user must enter to receive permission to access the project. A database is provided for maintaining project attributes. By default, when a subproject is created, it inherits the attributes of its parent project that are not inherently specific to its parent project. For example, a subproject inherits the password of its parent project but not the history list of its parent project.

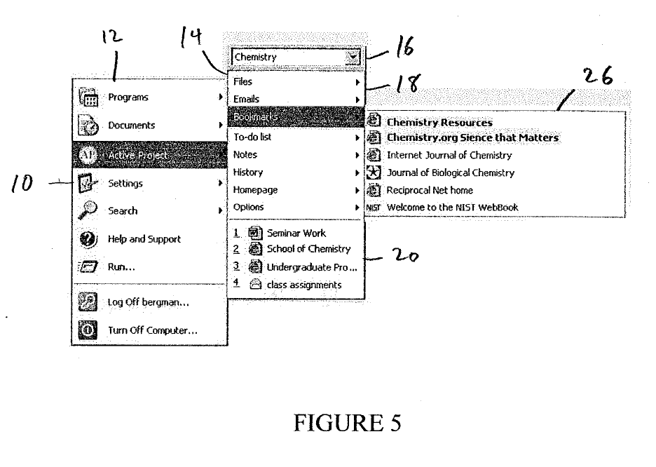

One important feature of the present invention is that identifiers of all the data objects assigned to a project are made collectively accessible to the user at the graphical user interface. FIG. 5 shows one way of modifying the graphical user interface of Microsoft Windows™ to accomplish this. An “active project” menu item is added to the Start pull-up menu 12. Selecting “active project” menu item 10 activates an active project menu 14 that includes an active project pull-down sub-menu 16 whose icon is the name of the currently active project, a data object type sub-menu 18 and a sub-menu 20 of identifiers of the most recently accessed data objects assigned to the active project named in the icon of active project sub-menu 16. Active project sub-menu 16 functions similarly to the pull-up menu associated with the active project bar at the bottom of the display of the graphical user interface: a left mouse click brings up a pull-up menu of projects that can be used to switch active projects or to cancel project activity as described above in connection with the active project bar at the bottom of the display of the graphical user interface. Selecting an entry such as “Files”, “Emails” or “Bookmarks” in data object type menu 18 brings up a submenu of identifiers of all the data objects of that type that have been assigned to the active project. Selecting “To-do list” brings up a display of data objects assigned to the active project that have been flagged as tasks. Selecting “Notes” brings up a list of memoranda of the user to him/herself in connection with the project. Selecting “History” brings up a display of the project history, in the form of a list, of identifiers of the data objects in the project history, that is more extensive than menu 20. This list is similar to the Microsoft Office™ history, but includes only identifiers of data objects that are assigned to the active project. Selecting “Homepage” activates the browser to display the active project's home page. Other options (not shown) include management tools such as a project calendar and a project Gantt chart. These management tools are considered herein to be among the attributes of the project. Selecting “Options” brings up a submenu of these options as well as menu items that allow a user to change project attributes such as the URL of the project's homepage, as well as general attributes such as the project root zone definitions.

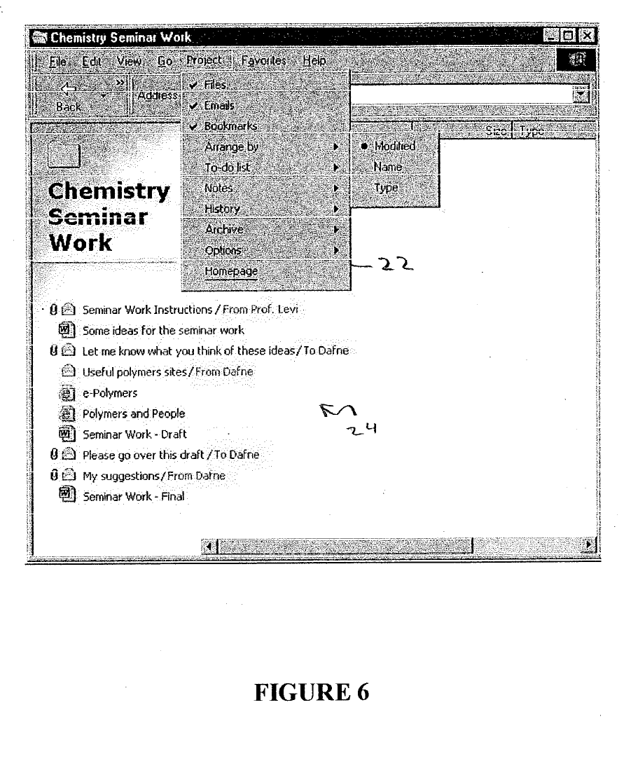

Alternatively, under the second preferred embodiment, identifiers of the data objects assigned to a project are made collectively accessible to the user simply by using the graphical user interface's own mechanism for displaying the contents of a folder. FIG. 6 shows an example of such a display in a modified Microsoft Windows™ window. The data object identifiers are displayed in a folder window list 24. The menu bar of the window includes a “Project” entry with a pull-down menu 22 that is similar to menu 18 of FIG. 5, except that pull-down menu 22 allows the user to activate and deactivate the displays of particular types of data objects. In the example of FIG. 6, “Files”, “Emails” and “Bookmarks” are activated, and so identifiers of only Microsoft Word™ documents, e-mail messages and bookmarks are displayed in the window. Note that activating a window of this type automatically makes the associated project the active project.

FIG. 5 also illustrates another aspect of the present invention: “pre-accessed bookmarks”. Prior art browsers allow a user to either open or save a document pointed to by a hyperlink. For example, in Microsoft Internet Explorer™, left-clicking a hyperlink opens the document pointed to by the hyperlink; and right-clicking the hyperlink and then left-clicking the “save target as . . . ” menu item calls up a window that allows the user to store the document in a desired location. According to the present invention, the browser allows the user to save, not the document, but the document's URL, in the form of a “pre-accessed bookmark”. This type of bookmark is called “pre-accessed” because it is saved without actually accessing the document to which it points. Typically, pre-accessed bookmarks are saved along with prior art bookmarks, in the browser's standard bookmark files or in locations associated with projects. By default, pre-accessed bookmarks are saved in a folder associated with the currently active project. In FIG. 5, the “Bookmarks” entry in data object type menu 18 has been activated, bringing up a submenu 26 of six bookmarks. Two of the bookmarks, “Chemistry Resources” and “Chemistry.org Science that Matters”, are pre-accessed bookmarks. The other four bookmarks, “Internet Journal of Chemistry”, “Journal of Biological Chemistry”, “Reciprocal Net home” and “Welcome to the NIST WebBook”, point to documents that have already been accessed either by being opened or by being saved. In this example, the pre-accessed bookmarks are distinguished from the other bookmarks by coming first in submenu 26 and by being displayed in bold font. When the document pointed to by a pre-accessed bookmark is accessed, the bookmark is converted to, and is subsequently displayed as, a prior art bookmark.

Unlike the schematic data object names in FIGS. 1-4, the names in the data object identifiers of FIGS. 5 and 6 are examples of names that real users give to real data objects.

Individual data objects may be assigned attributes of their own. One such attribute is the designation of a data object as a “task” that needs following up by the user. Another such attribute is the project itself to which a data object is assigned. The mechanism that the operating system uses to manipulate data object attributes is used to move data objects from one project to another (e.g. from a project to one of its subprojects). For example, when displays such as that of FIG. 6 are used, a data object is reassigned simply by dragging and dropping the data object's identifier from one project window to another project window, or alternatively by cutting and pasting the data object's identifier from one project window to another project window. In addition, under the first preferred embodiment, the listener keeps the project management database always current by monitoring operating system events such as “new”, “delete”, “change name” and “move” commands. Under the Microsoft Windows™ operating system, API functions such as FindFirstChangeNotification and FindNextChangeNotification are used for this purpose.

The present invention also allows the user to assign “correspondents” to a project. Once assigned, a correspondent is an attribute of the project. For example, a chemistry student can assign the Microsoft Outlook™ contacts of his or her professor and classmates to a “CHEMISTRY” project, and then inspect all incoming e-mail messages from these contacts and all outgoing e-mail messages to these contacts from menu 18 or window list 24 of the “CHEMISTRY” project while that project is active. The user does not need to engage in the tedious process of manually assigning every incoming e-mail to the correct subfolder of the Inbox because the present invention automatically assigns incoming-email to the correct projects. Preferably, this assignment of incoming e-mail to projects also is retroactive: old e-mail messages received from a correspondent before that correspondent was assigned to a project are assigned to the project along with the correspondent. Note that a correspondent can be assigned to more than one project. If a correspondent is assigned to more than one project, then the associated incoming e-mail messages are assigned to each project of which that correspondent is an attribute.

In the embodiment of the present invention that is illustrated in FIGS. 5 and 6, the data objects of both the active project and all of its subprojects are displayed, in the sub-menus invoked using menu 18 or in the window of FIG. 6. Alternatively, the data objects of the subprojects are not displayed. Instead, menus 18 and 22 include a “subprojects” entry whose invocation brings up a list of subprojects of the active project, and selecting one of the subprojects makes that subproject the active project.

Optionally, the second preferred embodiment of the present invention allows the archiving of data objects assigned to a project. While a data object is archived, its identifier is invisible under the ordinary mechanisms of collectively displaying identifiers of all the data objects assigned to a project. If the display mechanism of FIG. 5 is used, then identifiers of archived data objects are not displayed along with the identifiers of other data objects of the same type. If the graphical user interface's own window for displaying the contents of a folder is used under the second implementation of the organization of data objects into projects, identifiers of archived data objects are not displayed in the window at all. Pull-down menu 22 of FIG. 6 is shown as including an entry for accessing archived data objects separately from the other data objects. This option reduces the clutter in identifier displays of projects to which many data objects are assigned, while preserving the user's ability to retrieve archived data objects as needed, in close association with the archived data objects' original projects rather than from a hard to use and easily forgotten general archive. Note that menu 22 in FIG. 6 includes an entry for accessing and (optionally) de-archiving archived data objects.

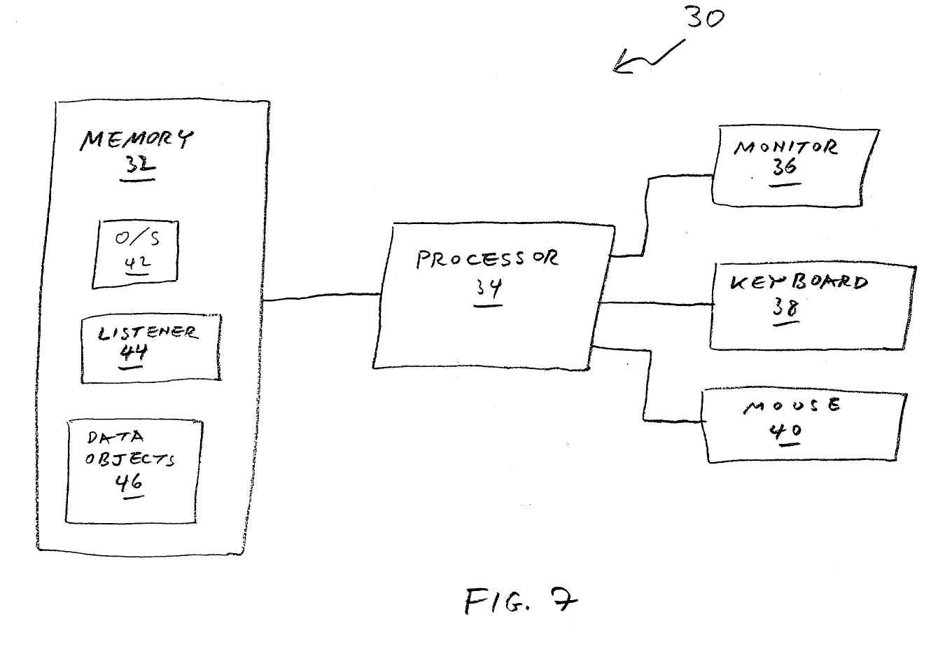

FIG. 7 is a high-level block diagram of a system 30 for implementing the method of the present invention. Data objects 46 are stored in a memory 32, along with, inter alia, operating system code 42 and code 44 for the background program that implements the present invention. Standard input and output devices, such as a video monitor 36, a keyboard 38 and a mouse 40, support a graphical user interface. Processor 34 executes operating system code 42 and background code 44, under user control, to assign data objects to projects, to activate one of the projects and to make the identifiers of the data objects assigned to the active project collectively accessible at the graphical user interface. Processor 34, by executing operating system code 42 and background code 44, also implements the various subsidiary aspects of the present invention, including project histories, project attributes, archiving and pre-accessed bookmarks.

While the invention has been described with respect to a limited number of embodiments, it will be appreciated that many variations, modifications and other applications of the invention may be made.

What is claimed is:

1. A method of managing a plurality of data objects organized according to a hierarchy, each data object having a respective type, comprising the steps of:
(a) assigning each of a plurality of sets of the data objects to a respective project in a manner independent of the respective types of the data objects; and
(b) designating a single one of said projects as an active project.

2. The method of claim 1, wherein at least one of said sets of the data objects includes data objects of at least two types selected from the list consisting of files, e-mail messages and browser bookmarks.

3. The method of claim 1, wherein said assigning is effected by steps including associating each said project with a respective at least one folder of the hierarchy.

4. The method of claim 3, wherein said associating is effected by steps including creating each said at least one folder in a corresponding project root zone.

5. The method of claim 4, wherein said project root zone is a folder of the hierarchy.

6. The method of claim 3, wherein said assigning includes constructing a database including paths to all said data objects of said sets.

7. The method of claim 3, wherein each said project is associated with a single respective folder of the hierarchy.

8. The method of claim 1, wherein said designating is effected by accessing one of the data objects that is assigned to said one project.

9. The method of claim 1, wherein said designating is effected by steps including:
(i) associating said one project with a folder of the hierarchy; and
(ii) accessing said folder.

10. The method of claim 1, further comprising the step of:
(c) providing at least one of said projects with at least one respective project attribute.

11. The method of claim 10, wherein, for each of said at least one project, said at least one respective project attribute is selected from the group consisting of a home page of said each project, a graphical design of said each project, a management tool of said each project, a note of said each project, a correspondent of said each project and a password of said each project.

12. The method of claim 11, wherein said management tool is selected from the group consisting of a calendar and a Gantt chart.

13. The method of claim 1, further comprising the step of:
(c) interactively marking at least one of the data objects assigned to said active project as a task.

14. The method of claim 1, further comprising the steps of:
(c) accessing a document that includes at least one hyperlink; and
(d) creating a new data object that corresponds to one of said at least one hyperlink and that is assigned to one of said projects.

15. The method of claim 14, wherein said new data object is a pre-accessed bookmark.

16. The method of claim 1, further comprising the step of:
(c) making respective identifiers of at least some of the data objects assigned to said active project collectively accessible at a graphical user interface.

17. The method of claim 16, wherein said making of said respective identifiers collectively accessible includes displaying said identifiers of said data objects of different types separately at said graphical user interface.

18. The method of claim 17, wherein all said identifiers of the data objects assigned to said active project are displayed together in a common window of said graphical user interface.

19. The method of claim 16, further comprising the step of:
(d) displaying a history of said active project at said graphical user interface.

20. The method of claim 1, further comprising the step of:
(c) creating a subproject of one of said projects.

21. The method of claim 20, further comprising the steps of:
(d) providing said one project with at least one project attribute; and
(e) bequeathing said at least one project attribute to said subproject.

22. The method of claim 20, further comprising the step of:
(d) for at least one data object assigned to said one project, reassigning said at least one data object to said subproject.

23. The method of claim 1, further comprising the step of:
(c) archiving at least one of the data objects assigned to said active project.

24. The method of claim 23, further comprising the step of:
(d) making respective identifiers of at least some of the data objects assigned to said active project, except for said at least one archived data object, collectively accessible at a graphical user interface.

25. The method of claim 1, further comprising the steps of:
(c) inactivating said active project; and
(d) designating a different single one of said projects as an active project.

26. A method of managing a plurality of data objects, each data object having a respective type, comprising the steps of:
(a) assigning each of a plurality of sets of the data objects to a respective project in a manner independent of the respective types of the data objects; and
(b) providing at least one said project with at least one respective project attribute.

27. The method of claim 26, wherein, for each of said at least one project, said at least one respective project attribute is selected from the group consisting of a home page of said each project, a graphical design of said each project, a management tool of said each project, a note of said each project and a correspondent of said each project.

28. A system for managing a plurality of data objects, each data object having a respective type, the system comprising:
(a) a memory for storing the data objects; and
(b) a processor for:
(i) assigning each of a plurality of sets of the data objects to a respective project in a manner independent of the respective types of the data objects; and
(ii) designating a single one of said projects as an active project.

29. The system of claim 28, wherein said processor is further operative to make respective identifiers of all the data objects assigned to said active project collectively accessible at a graphical user interface, the system further comprising:
(c) a mechanism for implementing said graphical user interface.

30. A computer readable storage medium having computer readable code embodied on the computer readable storage medium, the computer readable code for managing a plurality of data objects, each data object having a respective type, the computer readable code comprising:
(a) program code for assigning each of a plurality of sets of the data objects to a respective project in a manner independent of the respective types of the data objects; and
(b) program code for designating a single one of said projects as an active project.

31. The computer readable storage medium of claim 30, further comprising:
(c) program code for making respective identifiers of all the data objects assigned to said active project collectively accessible at a graphical user interface.
